(19) United States
(12) Patent Application Publication
(10) Pub. No.: US 2024/0017705 A1
(43) Pub. Date: Jan. 18, 2024

(54) PEDAL FEEL SIMULATOR

(71) Applicant: Robert Bosch GmbH, Stuttgart (DE)

(72) Inventors: Andreas Weh, Sulzberg (DE); Florian Breyer, Oberstaufen (DE); Harald Guggenmos, Immenstadt/Seifen (DE); Martin Hagspiel, Rettenberg (DE)

(21) Appl. No.: 18/304,889

(22) Filed: Apr. 21, 2023

(30) Foreign Application Priority Data
Jul. 15, 2022 (DE) 10 2022 207 233.2

(51) Int. Cl. B60T 8/40; F15B 15/14

(52) U.S. Cl. CPC B60T 8/409; F15B 15/1447

(57) ABSTRACT

In a pedal feel simulator, in particular for a vehicle brake system, with a piston guided axially displaceably in a cylinder bore against a spring force, the piston is designed in two parts from a first piston part and a second piston part, wherein the first piston part is adapted to be designed identically across several pedal feel simulator types, and the second piston part is designed with at least one different axial dimension across several pedal feel simulator types.

### CROSS REFERENCE

The present application claims the benefit under 35 U.S.C. 119 of German Patent Application No. DE 10 2022 207 233.2 filed on Jul. 15, 2022, which is expressly incorporated herein by reference in its entirety.

### BACKGROUND INFORMATION

The present invention relates to a pedal feel simulator, in particular for a vehicle brake system, with a piston guided axially displaceably against a spring force.

Conventional vehicle brake systems are used in motor vehicles, such as motorcycles, cars, or trucks, to provide controlled brake pressure to associated wheel brakes, thus implementing slip controls.

Newer vehicle developments allow for driving with increasing levels of automation, which also places new demands on associated systems, such as the brake system. In particular, pressure generation by means of an external power source must also be possible independently of a driver of the vehicle. At the same time, when actuating pedals in the vehicle, the driver must be given the impression that he himself is actively controlling the associated system.

For this purpose, pedal simulators, by means of which a system to be actuated is simulated on an associated pedal, are regularly used in vehicles. On the pedal, the driver of the vehicle is thus given mostly the same feeling as he would have during a self-actuating, i.e., not simulated, actuation of a comparable system.

It is an object of the present invention to provide a pedal simulator that is comparatively inexpensive and easy to assemble and at the same time particularly reliable in operation.

### SUMMARY

According to the present invention, a pedal feel simulator is provided, in particular for a vehicle brake system, with a piston guided axially displaceably in a cylinder bore against a spring force. The piston is designed according to an example embodiment of the present invention in two parts from a first piston part and a second piston part, wherein the first piston part is adapted to be designed identically across several pedal feel simulator types, and the second piston part is adapted to be designed with at least one different axial dimension across several pedal feel simulator types. In other words, according to the present invention, a pedal feel simulator series is created with at least two pedal feel simulators, each designed with a first piston part and a second piston part. In this case, the first piston parts in the at least two pedal feel simulators are designed identically and the second piston parts in the at least two pedal feel simulators are designed differently with regard to at least one axial dimension.

With the design according to an example embodiment of the present invention of pistons in pedal feel simulators, a particularly simple, inexpensive and at the same time particularly easy-to-assemble adaptation of such pedal feel simulators to different types of associated vehicle brake systems is possible. The second piston part according to the invention can be easily changed with regard to at least one of its axial dimensions so that different variants are possible overall solely by means of small adaptations to particularly few parts. Higher quantities and associated, advantageous quantity effects thus result for the remaining parts.

In an advantageous development of the pedal feel simulator according to the present invention, the first piston part is designed from a plastic material. Polypropylene styrene is particularly preferably selected as the plastic material. The plastic part of this kind, as a standard part, can advantageously be used across several types of pedal feel simulators as a common part.

Alternatively or additionally, in the pedal feel simulator according to the present invention, the second piston part is designed from a metal material. Such a metal part can advantageously be designed to be adaptable or changeable with regard to its outer dimensions, in particular by means of non-cutting shaping, such as punching or pressing, as well as by means of cutting shaping, such as milling or lathing. Accordingly, the second piston part of the pedal feel simulator according to the invention is furthermore preferably designed as a cold-formed part.

Moreover, according to an example embodiment of the present invention, the second piston part is preferably designed with a hollow cylindrical face end region, the axial length of which is adapted to be designed with at least one different axial dimension across several pedal feel simulator types. With such a variable or adjustable outer length dimension at one end region, the overall length of the piston can advantageously be adapted for different types of pedal feel simulators. According to this overall length, the piston can then generate respectively associated, type-related simulation characteristics.

According to an example embodiment of the present invention, the second piston part is furthermore advantageously designed with a hollow cylindrical, radially inside step region, the axial length of which is adapted to be designed with at least one different axial dimension across several pedal feel simulator types. With such a variable or adjustable inner length dimension at a step region, the support length and thus, at the same time, the effective length of a first spring element received in the piston part can advantageously be adapted for different types of pedal feel simulators. The first spring element serves as a counterpressure simulation of the pedal feel simulator and is preferably designed in the form of a coil spring.

Furthermore, according to an example embodiment of the present invention, the second piston part is advantageously designed with a stop shoulder for abutting against a stop means that is held in a stop groove in the associated cylinder bore. The stop means advantageously forms a stationary rest position for a second spring element of the pedal feel simulator, by means of which a counterpressure of externally actuated wheel brakes is then simulated.

The cylinder bore of the pedal feel simulator according to the invention is preferably adapted to be designed with at least one different axial dimension across several pedal feel simulator types with regard to the axial position of the stop groove in the cylinder bore. By means of the thus different stop positions on different pedal feel simulator types, the relative position between the piston and the aforementioned second spring element can be further adapted to likewise achieve advantageously different simulation characteristics.

Finally, in a further, preferable configuration of the pedal feel simulator according to an example embodiment of the present invention, the first piston part and the second piston part are connected to one another by means of an interference fit. Such an interference fit is inexpensive and can be produced in a particularly easy-to-assemble manner.

The present invention is furthermore also related to a use of several pedal feel simulators of the aforementioned type across several pedal feel simulator types.

An exemplary embodiment of the solution according to the present invention is explained below with reference to the figures.

### BRIEF DESCRIPTION OF THE DRAWINGS

FIG. 1 shows a schematic longitudinal section of an exemplary embodiment of a pedal feel simulator according to the related.

FIG. 2 shows a schematic longitudinal section of an exemplary embodiment of a pedal feel simulator according to the present invention with the brake pressure applied, with a first piston part and a second piston part.

FIG. 3 shows the detail III according to FIG. 2 with no brake pressure applied.

FIG. 4 shows a perspective view of the second piston part according to FIG. 2.

### DETAILED DESCRIPTION OF EXAMPLE EMBODIMENTS

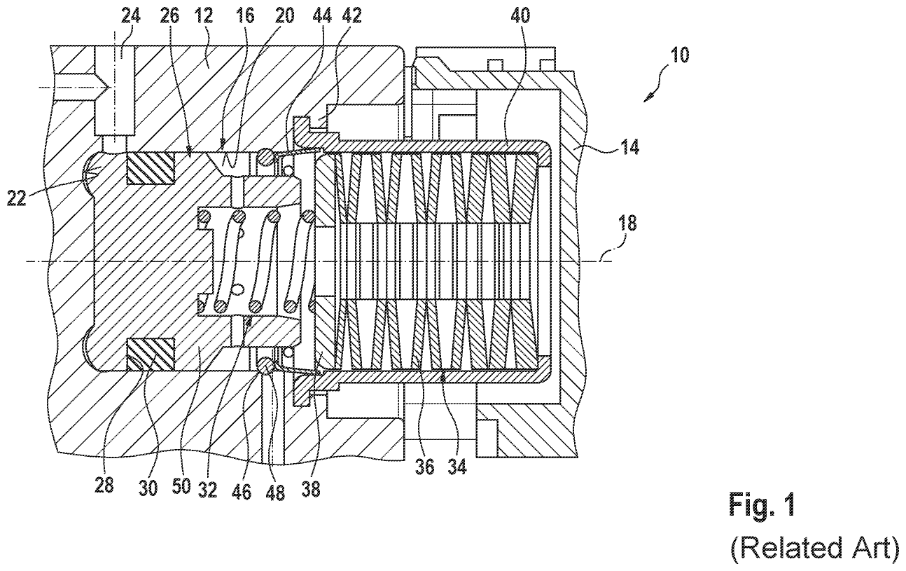

FIG. 1 illustrates a pedal feel simulator 10 according to the related art, which is formed from a hydraulic, substantially cuboidal housing 12, in particular in the form of an aluminum hydraulic block, as well as an electrical control unit 14 abutting thereon. A bag-shaped, stepped cylinder bore 16 is formed in the housing 12 and extends along a longitudinal axis 18. The cylinder bore 16 comprises a bore wall 20 and a bore bottom 22. In the region of the bore bottom 22, a hydraulic conduit 24 for supplying and discharging hydraulic fluid, in the present case in the form of brake fluid, to the cylinder bore 16 opens at the bore wall 20.

A piston 26, which has an outer circumferential groove 28, is received in the cylinder bore 16, wherein a circumferential annular seal 30 sealing toward the bore wall 20 is received in the groove 28. Inside the piston 26, a first spring element 32 in the form of a coil spring is received and pushes against a second spring element 34 in the direction out of the cylinder bore 16. The second spring element 34 is formed with several spring packs 36, which are supported with an end face against the first spring element 32 by means of a supporting disk 38. The other end face of the spring packs 36 is supported on the inside of a hat-shaped cover 40, which is attached in a stationary and fluid-tight manner to the housing 12 by means of a caulking 42 and projects into the control unit 14. Also arranged inside the hat-shaped cover 40 is an annular guide sleeve 44 in which the spring packs 36 are to be guided together with the supporting disk 38 when the second spring element 34 projects comparatively far into the cylinder bore 16. The guide sleeve 44 is held by means of a stop groove 46, formed in the bore wall 20, and a stop means 48, arranged in said stop groove, in the form of a clamping ring between the stop means 48 and the cover 40.

When brake pressure is applied to the conduit 24, in particular when a non-illustrated brake pedal is actuated by a driver of an associated vehicle, the piston 26 is first pushed against the first spring element 32 and subsequently against the second spring element 34 out of the cylinder bore 16. At its outer circumferential edge, the piston 26 has a stop shoulder 50 with which it ultimately strikes against the stop means 48, whereby its stroke path is limited overall.

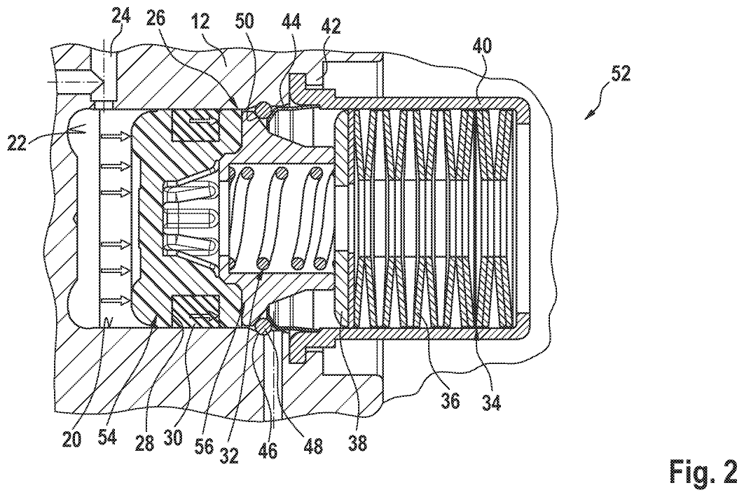

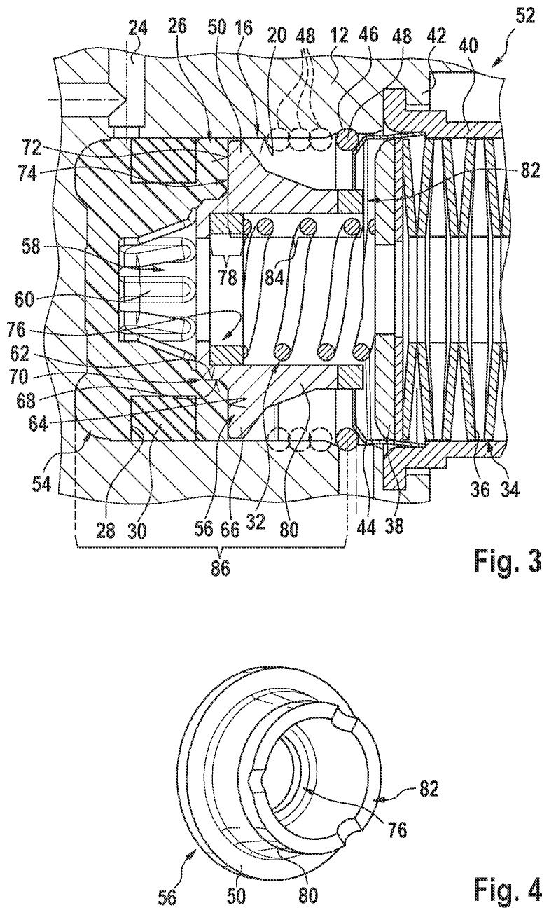

In FIGS. 2 to 4, a pedal feel simulator 52 according to the invention is illustrated, which likewise comprises a housing 12, as well as a cylinder bore 16 formed therein with a longitudinal axis 18, bore wall 20, bore bottom 22, conduit 24, piston 26, groove 28, seal 30, first spring element 32, second spring element 34, spring packs 36, supporting disk 38, cover 40, caulking 42, guide sleeve 44, stop groove 46, stop means 48, and stop shoulder 50.

However, in the design according to FIGS. 2 to 4, the piston 26 is formed in two parts with a cup-shaped, first piston part 54 of a plastic material and a substantially hollow cylindrical, second piston part 56 of a metal material.

On the inside, the first piston part 54 has a recess 58 which is provided with substantially axially extending ribs 60 on its outer wall. Inside the first piston part 54 at the end region facing the second piston part 56 are also a substantially axially extending, cylindrical first pressing surface 62 and a substantially radially extending, annular first stop surface 64. The second piston part 56 is designed with a ring portion 66 which faces the first piston part 54 and on which is formed a second pressing surface 68, which is likewise axial. The second pressing surface 68, together with the first pressing surface 62, forms an interference fit 70. Next to the second pressing surface 68 is a radial, second stop surface 72, which, together with the first stop surface 64, forms an axial support 74 between the first piston part 54 and the second piston part 56.

Inside the substantially hollow cylindrical, second piston part 56 is a step region 76 having a first axial dimension 78. Furthermore, at a sheath portion 80 of the substantially hollow cylindrical, second piston part 56, which sheath portion adjoins the ring portion 66, is an end region 82 of the second piston part 56, which end region faces the second spring element 34 and likewise has a special second axial dimension 84. The two axial dimensions 78 and 84 can be changed in a particularly simple manner by means of compensation parts (not shown) to be applied to the second piston part 56, and preferably by shaping, in particular cold forming the material of the metallic second piston part 56, for forming different types of pedal feel simulators 52.

Furthermore, in the pedal feel simulator 52 according to FIGS. 2 to 4, the position of the stop groove 46 and thus of the stop means 48 can be changed along the longitudinal axis 18 so that a different, type-dependent third axial dimension 86 can in each case be obtained for the stop means 48.

What is claimed is:

1. A pedal feel simulator for a vehicle brake system, comprising:
a piston guided axially displaceably against a spring force in a cylinder bore, the piston being formed by two parts from a first piston part and a second piston part, wherein the first piston part is adapted to be identical across several pedal feel simulator types, and the second piston part is adapted to be have at least one different axial dimension across several pedal feel simulator types.

2. The pedal feel simulator according to claim 1, wherein the first piston part is formed from a plastic material.

3. The pedal feel simulator according to claim 1, wherein the second piston part is formed from a metal material.

4. The pedal feel simulator according to claim 1, wherein the second piston part is a cold-formed part.

5. The pedal feel simulator according to claim 1, wherein the second piston part has a hollow cylindrical face end region, an axial length of which is adapted to have at least one different axial dimension across several pedal feel simulator types.

6. The pedal feel simulator according to claim 1, wherein the second piston part includes a hollow cylindrical, radially inside step region, an axial length of the step region being adapted to have at least one different axial dimension across several pedal feel simulator types.

7. The pedal feel simulator according to claim 1, wherein the second piston part has a stop shoulder for abutting against a stop held in a stop groove in the cylinder bore.

8. The pedal feel simulator according to claim 7, wherein the cylinder bore is adapted to have at least one different axial dimension across several pedal feel simulator types with regard an the axial position of the stop groove in the cylinder bore.

9. The pedal feel simulator according to claim 1, wherein the first piston part and the second piston part are connected to one another by an interference fit.

10. A method, comprising:
providing several pedal feel simulators for respective vehicle brake systems, each of the pedal feel simulators including a piston guided axially displaceably against a spring force in a cylinder bore, the piston being formed by two parts from a first piston part and a second piston part, wherein the first piston part is adapted to be identical across several pedal feel simulator types, and the second piston part is adapted to be have at least one different axial dimension across several pedal feel simulator types; and
using the pedal feel simulators in the several pedal feel simulator types.
